(19) United States
(12) Patent Application Publication
(10) Pub. No.: US 2025/0232773 A1
(43) Pub. Date: Jul. 17, 2025

(54) SPEECH RECOGNITION METHOD AND SPEECH RECOGNITION DEVICE

(71) Applicant: HONDA MOTOR CO., LTD., Tokyo (JP)

(72) Inventors: Yui Sudo, Wako-shi (JP); Shakeel Muhammad, Wako-shi (JP); Yosuke Fukumoto, Tokyo (JP)

(21) Appl. No.: 19/021,279

(22) Filed: Jan. 15, 2025

(30) Foreign Application Priority Data
Jan. 17, 2024 (JP) 2024-005639

(51) Int. Cl. G10L 15/26; G10L 15/08

(52) U.S. Cl. CPC G10L 15/26; G10L 15/08

(57) ABSTRACT

This paper proposes an attention-based contextual biasing method that can be customized using an editable phrase list (referred to as a bias list). The proposed method can be trained effectively by combining a bias phrase index loss and special tokens to detect the bias phrases in the input speech data.

### CROSS-REFERENCE TO RELATED APPLICATION

The present application claims priority based on Japanese Patent Application No. 2024-005639 filed Jan. 17, 2024, the content of which is incorporated herein by reference.

### TECHNICAL FIELD

The present invention relates to an attention-based contextual biasing method that can be customized using an editable phrase list.

### BACKGROUND

End-to-end (E2E) automatic speech recognition (ASR) methods exhibit remarkable performance. However, since the performance of such methods is intrinsically linked to the context present in the training data, E2E-ASR methods do not perform as desired for unseen user contexts (e.g., technical terms, personal names, and playlists). Thus, E2E-ASR methods must be easily contextualized by the user or developer.

### SUMMARY

This paper proposes an attention-based contextual biasing method that can be customized using an editable phrase list (referred to as a bias list). The proposed method can be trained effectively by combining a bias phrase index loss and special tokens to detect the bias phrases in the input speech data. In addition, to improve the contextualization performance during inference further, we propose a bias phrase boosted (BPB) beam search algorithm based on the bias phrase index probability. Experimental results demonstrate that the proposed method consistently improves the word error rate and the character error rate of the target phrases in the bias list on both the Librispeech-960 (English) and our in-house (Japanese) dataset, respectively.

### BRIEF DESCRIPTION OF THE DRAWINGS

FIG. 1: Overall architecture of the proposed method, including the audio encoder, bias encoder, and bias decoder. The BPB beam search algorithm is used during inference.

FIG. 1A: A bias phrase boosted (BPB) beam search algorithm that exploits the bias phrase probability.

FIG. 1B: Table 1: Preliminary analysis on the Librispeech-100 test-clean.

FIG. 2: Effect of the bias phrase index loss. The horizontal and vertical axes show token index s and bias phrases in B, respectively.

FIG. 2A: Table 2: Main WER results obtained on Librispeech-960 data (U-WER/B-WER). Bold values indicate cases where the proposed method outperformed the baselines, and underlined values represent the best results.

FIG. 3: Effect of the decoding weight αbonus of the BPB beam search on Librispeech-960.

FIG. 4: Typical example. Bolded faces, red and blue faces represent the bias phrases, incorrectly and correctly recognized, respectively.

FIG. 5: Table 3: Experimental results on our in-house Japanese dataset.

### DETAILED DESCRIPTION

### 1. Introduction

End-to-end (E2E) automatic speech recognition (ASR) [1, 2] methods directly convert acoustic feature sequences to token sequences without requiring the multiple components used in conventional ASR systems, such as acoustic models (AM) and language models (LM). Various E2E-ASR methods have been proposed previously, including connectionist temporal classification (CTC) [3], recurrent neural network transducer (RNN-T) [4], attention mechanism [5, 6], and their various hybrid systems [7-9]. Since the effectiveness of E2E-ASR methods is inherently related to the context in the training data, performance expectations may not be satisfied consistently for the given user context. For example, personal names and technical terms tend to be important keywords in different contexts, but such terms may not appear frequently in the available training data, which would result in poor recognition accuracy. It is impractical to train a model for all contexts during training; thus, the user or developer should be able to contextualize the model easily without training.

A typical approach to this problem is shallow fusion using an external LM [10-14]. For example, [10-12] used a weighted finite state transducer (WFST) to construct an in-class LM to facilitate contextualization for the target named entities. Neural LM fusion methods have been also proposed [13,14]. The LM fusion technique attempts to enhance accuracy by combining an E2E-ASR model with an external neural LM and then rescoring the hypotheses generated by the E2E-ASR model. However, whether employing WFST or neural LMs, training an external LM requires additional training steps.

Thus, several methods have been proposed that do not require retraining. These methods include knowledge graph modeling for recognizing out-of-vocabulary named entities, contextual spelling correction using an editable phrase list, and named entity aware ASR model that recognize specific named entities based on phoneme similarity. However, these methods have limitations, such as requiring a speech synthesis (TTS) model for training and not being able to handle words other than predefined target named entities.

Deep biasing methods [17-20] provide an alternative approach to realize effective contextualization without requiring retraining processes and TTS models. In such methods, the E2E-ASR model can be contextualized using an editable phrase list, which is referred to as a bias list in this paper. Most deep biasing methods implement a cross-attention layer between the bias list and input sequences to recognize the bias phrases correctly. However, it has been observed that simply adding a cross-attention layer for the bias list is not effective [21]. Thus, [21, 22] introduced an additional branch designed to detect bias phrases, which indirectly helps to update the parameters of the cross-attention layer through an auxiliary loss. In contrast, [23, 24] introduced an auxiliary loss function directly on the cross-attention layer (referred to as bias phrase index loss and will be described in Section 3.2), which detects to the bias phrase index. While this approach allows for a direct parameter update of the cross-attention layer, it cannot distinguish whether the output tokens come from the bias list or not. In addition, requires two-stage training using a pretrained ASR model, which is time consuming.

This paper proposes a deep biasing method that employs both an auxiliary loss directly on the cross-attention layer, termed as bias phrase index loss, and special tokens for bias phrases to realize more effective bias phrase detection. Unlike conventional indirect methods [21,22], our method facilitates the effective training of the crossattention layer through the bias phrase index loss. Additionally, our technique departs from current methods by introducing special tokens for bias phrases. This allows the model to focus on the bias phrases more effectively, eliminating the need for a two-stage training process. Furthermore, we propose a bias phrase boosted (BPB) beam search algorithm that integrates the bias phrase index probability during inference, augmenting the performance in bias phrase recognition. The main contributions of this study are as follows:
We propose a deep biasing model that utilizes both bias phrase index loss and special tokens for the bias phrases.
We propose a bias phrase boosted (BPB) beam search algorithm to further improve the performance for the target phrases.
We demonstrate that the proposed method is effective for both the Librispeech-960 and our in-house Japanese dataset.

### 2. ATTENTION-BASED ENCODER-DECODER ASR

This section describes an attention-based encoder-decoder system that consists of an audio encoder and an attention-based decoder, which are extended to the proposed method.

### 2.1. Audio Encoder

The audio encoder comprises two convolutional layers, a linear projection layer, and Ma Conformer blocks [25]. The Conformer encoder transforms an audio feature sequenceX to T length hidden state vectors H=[h₁, . . . , hᵣ]∈R^{Txd} where d represents the dimension as follows:

$$H = AudioEnc ( X ) . \qquad ( 1 )$$

### 2.2. Attention-Based Decoder

The posterior probability is formulated as follows:

$${P}_{att} ( y \vert X ) = {\prod }_{s = 1}^{S} P ( {y}_{s} \vert {y}_{0 : s - 1} , X ) , \qquad ( 2 )$$

where s and S represent the token index and the total number of tokens, respectively. Given H generated by the audio encoder in Eq. (1) and the previous token sequence y_{0:s-1}, the attention-based decoder recursively estimates the next token yₛ as follows:

$$P ( {y}_{s} \vert {y}_{0 : s - 1} , X ) = AttnDec ( {y}_{0 : s - 1} , H ) . \qquad ( 3 )$$

The attention-based decoder comprises an embedding layer with a positional encoding layer, Ma Transformer blocks, and a linear layer. Each Transformer block has a multiheaded self-attention layer, a cross-attention layer (i.e., audio attention), and a linear layer with

layer normalization (LN) layers and residual connections. Here, the audio attention layer including the LN is formulated as follows:

$${U}^{′} = Soft max ( \frac{LN ( U ) {H}^{T}}{\sqrt{d}} ) H + U , \qquad ( 4 )$$

where U and U′ represent the input and output of the audio attention layer, respectively. In addition, the hybrid CTC/attention model [7] includes a CTC decoder. The attention-based decoder will be extended to the proposed bias decoder in Section 3.2.

### 3. PROPOSED DEEP BIASING METHOD

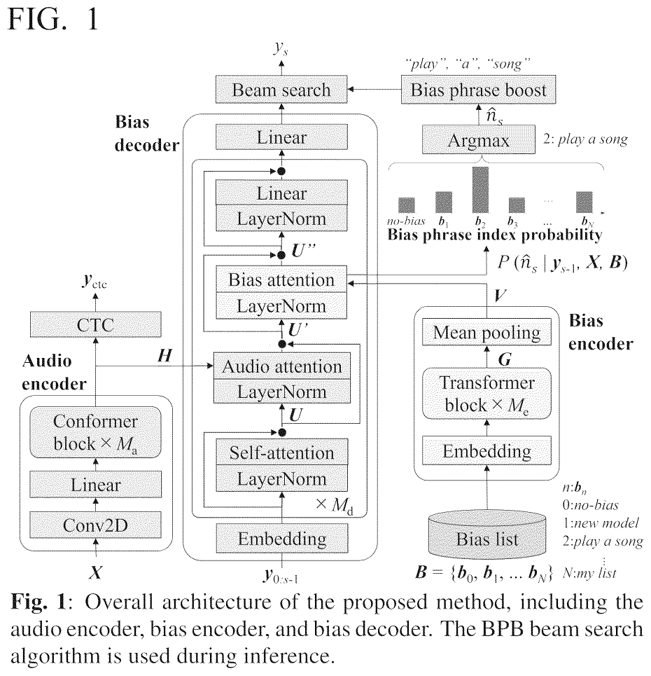

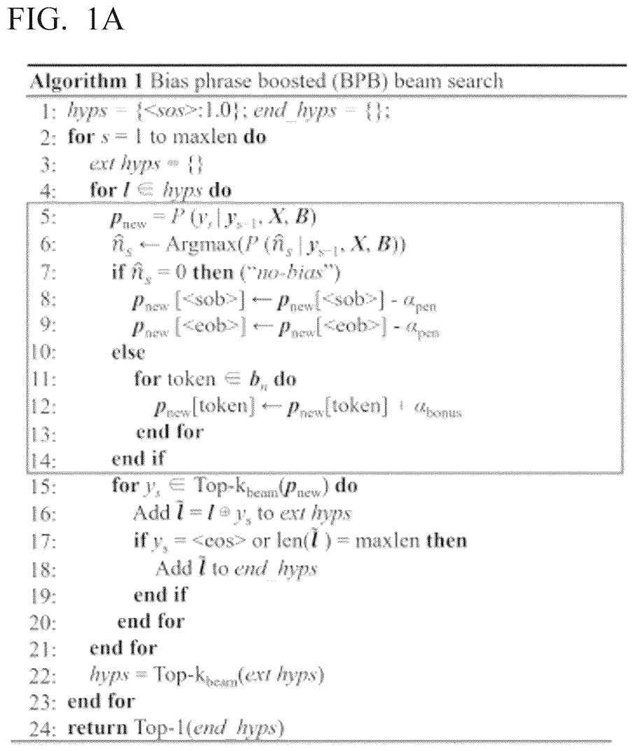

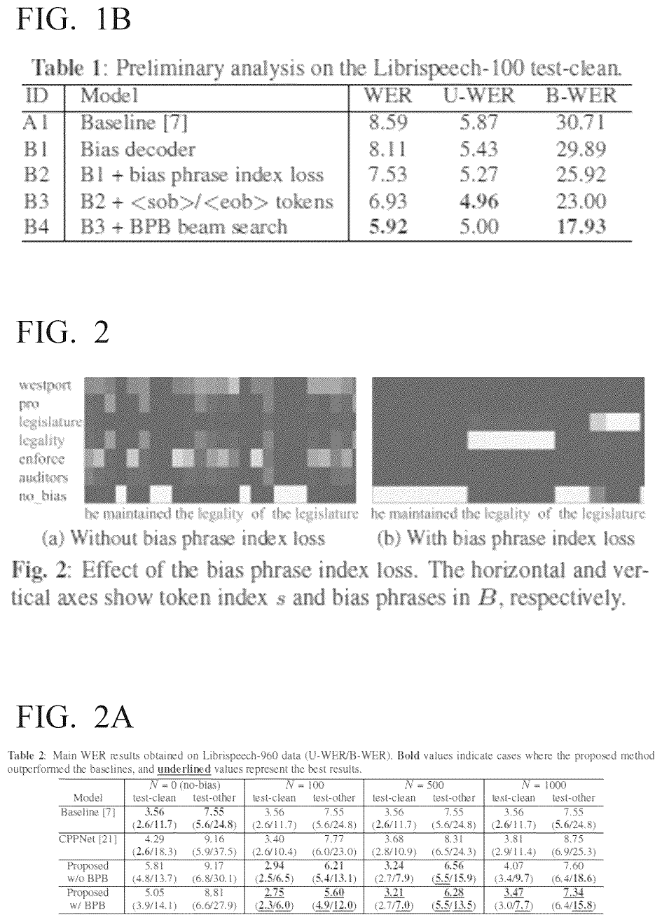

FIG. 1 shows the overall architecture of the proposed method, which comprises the audio encoder, bias encoder, and bias decoder. These components are described in the following subsections.

### 3.1. Bias Encoder

The bias encoder comprises an embedding layer with a positional encoding layer, Mₑ Transformer blocks, a mean pooling layer, and a bias list B={b₀, b₁, . . . b_{N}}, where n and bₙ represent the bias phrase index and the token sequence of the n-th bias phrase (e.g., “play a song”), respectively. Here, b₀ is a dummy phrase which means “no-bias”. After applying zero padding based on the max token length Lₘₐₓ in the bias list B, the embedding layer and the Transformer blocks extract a set of token-level feature sequences, G∈R^{(N+1)×Lmax×d} as follows:

$$G = Transformer ( Embedding ( B ) ) . \qquad ( 5 )$$

Then, mean pooling is performed to extract a phrase-level feature sequence, V=[v₀, v₁, . . . , v_{N}]∈R^{(N+1)×d}, as follows:

$$V = MeanPool ( G ) . \qquad ( 6 )$$

### 3.2. Bias Decoder

The bias decoder is an extension of the attention-based decoder described in Section 2.2, where an additional cross-attention layer (i.e., bias attention) is introduced to each Transformer block, as shown in FIG. 1. Unlike Eq. (2), the posterior probability is formulated using the bias list B as follows:

$$\text{?} ( y \vert X , B ) = {\prod }_{s = 1}^{S} P ( \text{?} \vert {y}_{0 : s - 1} , X , B ) . \qquad ( 7 )$$

$$\text{?} \text{indicates text missing or illegible when filed}$$

GivenH, V in Eqs. (1), (6), and y_{0:s-1}, the bias decoder estimates the next token yₛ recursively, unlike Eq. (3), as follows:

$$P ( {y}_{s} \vert {y}_{0 : s - 1} , X , B ) = BiasDec ( {y}_{0 : s - 1} , H , V ) . \qquad ( 8 )$$

In the Transformer block of the bias decoder, the bias attention layer including the LN is formulated as follows:

$${U}^{″} = Soft max ( \frac{LN ( {U}^{′} ) {V}^{T}}{\sqrt{d}} ) V + {U}^{′} . \qquad ( 9 )$$

In addition, the bias attention layer estimates the bias phrase index sequence în=[\hat{ }n₁, \hat{ }n₂, . . . , \hat{ }n_{S}] as follows:

$$\text{?} ( \text{?} \vert X , B ) = {\prod }_{s = 1}^{S} P ( \text{?} \vert {y}_{0 : s - 1} , X , B ) , \qquad ( 10 )$$

$$P ( \text{?} \vert {y}_{0 : s - 1} , X , B ) = Soft max ( \frac{LN ( \text{?} ) {V}^{T}}{\sqrt{d}} ) , \qquad ( 11 )$$

$$\text{?} \text{indicates text missing or illegible when filed}$$

where u′ₛ denotes the s-th feature vector of U′=[u′₀, u′₁, . . . , u′_{S}]. For example, if a bias phrase, “play a song” with a bias index of 2 (FIG. 1) is detected in a complete utterance, “I play a song today”, the bias phrase index sequence \hat{ }n=[0, 2, 2, 2, 0]. Model parameters are optimized using the cross entropy losses as follows:

$${L}_{batt} = CrossEntropy ( \text{?} , {P}_{batt} ( y \vert X , B ) ) , \qquad ( 12 )$$

$${L}_{bidx} = CrossEntropy ( \text{?} , {P}_{bidx} ( \hat{n} \vert X , B ) ) , \qquad ( 13 )$$

$$\text{?} \text{indicates text missing or illegible when filed}$$

where y_{gt} and \hat{ }n_{gt} represent the one-hot vector sequences of the reference transcription and the reference bias phrase index including the no-bias option. Here, we refer to L_{bidx} as bias phrase index loss, respectively.

### 3.3. Training

During the training process, a bias list B is created randomly from the corresponding reference transcriptions for each batch. Specifically, 0 to Nᵤₜₜ bias phrases of 2 to Lₘₐₓ token lengths are extracted uniformly for each utterance, resulting in a total of N bias phrases (Nᵤₜₜ×n_{batch}). After the bias list B is extracted randomly, special tokens (<sob>/<eob>) are inserted before and after the extracted phrases in the reference transcription to distinguish whether the output tokens come from the bias list or not. The proposed method is optimized via multitask learning using the weighted sum of losses, as expressed in Eqs. (12), (13), and the CTC loss (L_{ctc}):

$$L = {λ}_{ctc} {L}_{ctc} + {λ}_{batt} {L}_{batt} + {λ}_{bidx} {L}_{bidx} , \qquad ( 14 )$$

where λ_{ctc}, λ_{batt}, and λ_{bidx} represent the training weights.

### 3.4. BPB Beam Search Algorithm

We also propose a bias phrase boosted (BPB) beam search algorithm that exploits the bias phrase probability as described in Algorithm 1. The bias decoder calculates the token probability p_{new} including the special tokens, <sob>/<eob>, using Eq. (8) (line 5). We then estimate the bias phrase index \hat{ }nₛ using Eq. (11) and the argmax function (line 6). Here, the number of bias phrases N in the bias list B can increase significantly during inference, which would reduce the peak value after applying the softmax function in Eq. (9). Thus, Eq. (9) is approximated using the top k_{score} pruning as follows:

$${U}^{″} = Soft max ( {Top\_k}_{score} ( \frac{LN ( {U}^{′} ) {V}^{T}}{\sqrt{d}} ) ) V + {U}^{′} . \qquad ( 15 )$$

Then, if \hat{ }nₛ=0 (i.e., “no-bias”), the token probabilities for the special tokens p_{new}[sob] and p_{new}[eob] are penalized based on the weight αₚₑₙ (line 8, 9), otherwise, the corresponding token probabilities are increased according to the weight α_{bonus} (line 11-13). For example, if the detected bias phrase is “play a song”, the token probabilities for “play”, “a”, and “song” are increased with α_{bonus}. Based on the boosted probabilities p_{new}, the top k_{beam} pruning is performed as in the conventional beam search [7].

### 4. EXPERIMENT

### 4.1. Experimental Setup

The input features are 80-dimensional Mel filterbanks with a window size of 512 samples and a hop length of 160 samples. Then, SpecAugment [26] is applied. The audio encoder has two convolutional layers with a stride of two for downsampling, a 256-dimensional linear projection layer, and 12 Conformer blocks with 1024 linear units. The bias encoder and the bias decoder have three Transformer blocks with 1024 linear units and six Transformer layers with 2048 units, respectively. The attention layers in the audio encoder, the bias encoder, and the bias decoder are 4-multihead attentions with a dimension, d, of 256. During the training process, a bias list B is created randomly for each batch with Nᵤₜₜ=2 and Lₘₐₓ=10 described in Section 3.3. In this experiment, the bias list B has a total of N=50 to 200 bias phrases within a batch. The training weights λ_{cte}, λ_{batt}, and λ_{bidx} (described in Eq. (14)) are set to 0.3, 0.7, and 1.0, respectively. The proposed model is trained 150 epochs at a learning rate of 0.0015 with 15,000 warmup steps using the Adam optimizer. During the decoding process, the hyper parameters of k_{beam}, k_{score}, α_{bonus}, and Open (Section 3.4) are set to 20, 50, 1.0 and 10.0, respectively.

The Librispeech corpus (960 h, 100 h) [27] is used to evaluate the proposed method using ESPnet as the E2E-ASR toolkit [28]. The proposed method is evaluated in terms of word error rate (WER), bias phrase WER (B-WER), and unbiased phrase WER (U-WER) [29]. Note that insertion errors are counted toward B-WER if the inserted phrases are present in the bias list; otherwise, insertion errors are counted toward the U-WER. The goal of the proposed method is to improve the B-WER with a slight degradation in the U-WER and overall WER.

### 4.2. Preliminary Analysis of the Proposed Techniques

Firstly, we verify the effect of the proposed techniques on the Librispeech-100 as a preliminary experiment. Table 1 shows the effect of the bias phrase index loss, L_{bidx} described in Eq. (13), the special tokens for the bias phrases (<sob>/<eob>), and the BPB beam search on the Librispeech-100 test-clean evaluation set with a bias list size of N=100. Comparing with the baseline (the hybrid CTC/attention model [7]), simply introducing the bias attention layer does not improve the performance (A1 vs. B1), whereas the bias phrase index loss improves the B-WER significantly, which results in an improvement to the overall WER (B1 vs. B2). FIG. 2 shows the visualization results of the bias phrase index probabilities described in Eq. (11). The bias phrase index probabilities are estimated correctly by introducing the bias phrase index loss, L_{bidx} in Eq. (13). In addition, introducing the special tokens (<sob>/<eob>) further improves the B-WER (B2 vs. B3). Furthermore, the BPB beam search technique significantly improves the B-WER with a slight degradation in U-WER (B3 vs. B4).

### 4.3. Main Results

Table 2 shows the results obtained by the proposed method on the Librispeech-960 data for different bias list sizes N. Baseline is the hybrid CTC/attention model [7]. When the bias list size N=100, the proposed method improves the B-WER, which in turn significantly

improves the U-WER and WER. In addition, the proposed BPB beam search technique further improves the B-WER without degrading the overall WER and U-WER. The B-WER and U-WER tend to deteriorate as the number of bias phrases N increased; however, the proposed BPB beam search technique is particularly effective in terms of suppressing the deterioration of the B-WER. As a result, the proposed method outperforms the baseline in terms of both WER and B-WER. Although the proposed method underperforms the baseline when no bias phrases are used (N=0), we do not consider it as a critical issue because the users usually register important keywords for them.

### 4.4. Analysis of the BPB Beam Search Algorithm

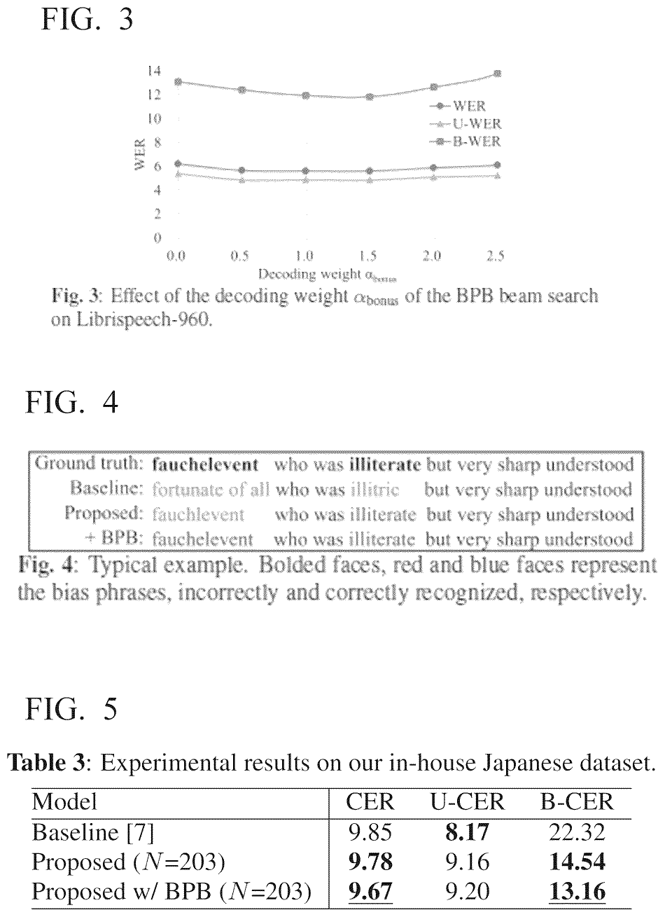

FIG. 3 shows the effect of the decoding weight α_{bonus} of the BPB beam search on the Librispeech-960 test—other with a bias list size of N=100. Although, even without using the proposed BPB beam search technique, the proposed method improves the B-WER as described in Section 4.3, the BPB beam search technique further improves the B-WER. When the decoding weight α_{bonus}>1.5, the B-WER, U-WER, and the overall WER deteriorate. The B-WER, U-WER, and the overall WER are the best at α_{bonus}=1.0.

FIG. 4 illustrates the inference results from three distinct approaches: the baseline method, our proposed method excluding the BPB beam search technique, and our proposed method incorporating the BPB beam search technique. Here, bolded face represents the bias phrases, and words in red and blue represent incorrectly and correctly recognized words, respectively. Even without the BPB beam search technique, the proposed method reduces the misrecognition of the bias phrases compared to the baseline; however, some bias phrases are not correctly recognized even when the correct bias phrase index is estimated. In contrast, the proposed BPB beam search technique recognizes the bias phrases more correctly.

### 4.5. Validation on Japanese Dataset

We also validate the proposed method on our in-house dataset containing 93 hours of Japanese speech data, including meeting and morning assembly scenarios, the Corpus of Spontaneous Japanese (581 h) [30], and 181 hours of Japanese speech in the database developed by the Advanced Telecommunications Research Institute International with the same experimental setup described in Section 4.1. Table 3 shows the evaluation results obtained on the inhouse dataset when N=203 phrases, such as personal names and technical terms, are registered in the bias list B. The proposed method improves the B-CER significantly with a slight degradation in the overall CER. Thus, the proposed method is effective for both English and Japanese languages.

### 5. CONCLUSION

This study introduces a deep biasing model incorporating bias phrase index loss and specialized tokens for bias phrases. Additionally, the BPB beam search technique is employed, leveraging bias phrase index probabilities to enhance accuracy. Experimental results demonstrate that our model enhances both WER and B-WER performances. Notably, the BPB beam search boosts B-WER performance with minimal impact on overall WER, evident in both English and Japanese datasets.

### 6. REFERENCES

[1] Rohit Prabhavalkar, Takaaki Hori, Tara N Sainath, Ralf Schl″uter, and Shinji Watanabe, “End-to-end speech recognition: A survey,” arXiv preprint arXiv: 2303.03329, 2023.
[2] Jinyu Li et al., “Recent advances in end-to-end automatic speech recognition,” APSIPA Transactions on Signal and Information Processing, vol. 11, no. 1.
[3] Alex Graves, Santiago Fernandez, Faustino Gomez, and J″urgen Schmidhuber, “Connectionist temporal classification: Labelling unsegmented sequence data with recurrent neural networks,” in Proc. ICML, 2006, pp. 369-376.
[4] Alex Graves, “Sequence transduction with recurrent neural networks,” in Proc. ICML, 2012.
[5] Jan K Chorowski, Dzmitry Bahdanau, Dmitriy Serdyuk, Kyunghyun Cho, and Yoshua Bengio, “Attention-based models for speech recognition,” Advances in neural information processing systems, vol. 28, 2015.
[6] William Chan, Navdeep Jaitly, Quoc Le, and Oriol Vinyals, “Listen, attend and spell: A neural network for large vocabulary conversational speech recognition,” in Proc. ICASSP, 2016, pp. 4960-4964.
[7] Shinji Watanabe, Takaaki Hori, Suyoun Kim, John R Hershey, and Tomoki Hayashi, “Hybrid ctc/attention architecture for end-to-end speech recognition,” IEEE Journal of Selected Topics in Signal Processing, vol. 11, no. 8, pp. 1240-1253, 2017.
[8] Tara N Sainath et al., “Two-pass end-to-end speech recognition,” arXiv preprint arXiv: 1908.10992, 2019.
[9] Yui Sudo, Muhammad Shakeel, Brian Yan, Jiatong Shi, and Shinji Watanabe, “4D ASR: Joint modeling of CTC, attention, transducer, and mask-predict decoders,” in Proc. Interspeech, 2023, pp. 3312-3316.
[10] Rongqing Huang, Ossama Abdel-Hamid, Xinwei Li, and Gunnar Evermann, “Class 1m and word mapping for contextual biasing in end-to-end asr,” in Proc. Interspeech, 2020, pp. 4348-4351.
[11] Ian Williams, Anjuli Kannan, Petar Aleksic, David Rybach, and Tara Sainath, “Contextual speech recognition in end-toend neural network systems using beam search,” in Proc. Interspeech, 2018.
[12] Atsushi Kojima, “A study of biasing technical terms in medical speech recognition using weighted finite-state transducer,” Journal of the Acoustical Society of Japan, vol. 43, pp. 66-68, 2022.
[13] Anjuli Kannan, Yonghui Wu, Patrick Nguyen, Tara N Sainath, Zhijeng Chen, and Rohit Prabhavalkar, “An analysis of incorporating an external language model into a sequence-tosequence model,” in Proc. ICASSP, 2018, pp. 5824-5828.
[14] Anuroop Sriram, Heewoo Jun, Sanjeev Satheesh, and Adam Coates, “Cold fusion: training seq2seq models together with language models,” in Proc. Interspeech, 2018, pp. 387-391.
[15] Xiaoqiang Wang et al., “Towards contextual spelling correction for customization of end-to-end speech recognition systems,” IEEE Trans. Audio, Speech, Lang. Process., vol. 30, pp. 3089-3097, 2022.
[16] Yui Sudo, Kazuya Hata, and Kazuhiro Nakadai, “Retrainingfree customized asr for enharmonic words based on a namedentity-aware model and phoneme similarity estimation,” in Proc. Interspeech, 2023, pp. 3312-3316.
[17] Golan Pundak, Tara N Sainath, Rohit Prabhavalkar, Anjuli Kannan, and Ding Zhao, “Deep context: End-to-end contextual speech recognition,” in Proc. SLT, 2018, pp. 418-425.
[18] Mahaveer Jain, Gil Keren, Jay Mahadeokar, and Yatharth Saraf, “Contextual rnn-t for open domain asr,” in Proc. Interspeech, 2020, pp. 11-15.
[19] Antoine Bruguier, Rohit Prabhavalkar, Golan Pundak, and Tara N Sainath, “Phoebe: Pronunciation-aware contextualization for end-to-end speech recognition,” in Proc. ICASSP, 2019, pp. 6171-6175.
[20] Saket Dingliwal, Monica Sunkara, Srikanth Ronanki, Jeff Farris, Katrin Kirchhoff, and Sravan Bodapati, “Personalization of ctc speech recognition models,” in Proc. SLT, 2023, pp. 302-309.
[21] Kaixun Huang, Ao Zhang, Zhanheng Yang, Pengcheng Guo, Bingshen Mu, Tianyi Xu, and Lei Xie, “Contextualized Endto-End Speech Recognition with Contextual Phrase Prediction Network,” in Proc. Interspeech, 2023, pp. 4933-4937.
[22] Minglun Han, Linhao Dong, Zhenlin Liang, Meng Cai, Shiyu Zhou, Zejun Ma, and Bo Xu, “Improving end-to-end contextual speech recognition with fine-grained contextual knowledge selection,” in Proc. ICASSP, 2022, pp. 491-495.
[23] Christian Huber, Juan Hussain, Sebastian St″uker, and Alexander Waibel, “Instant one-shot word-learning for contextspecific neural sequence-to-sequence speech recognition,” in Proc. ASRU, 2021, pp. 1-7.
[24] Shilin Zhou, Zhenghua Li, Yu Hong, Min Zhang, Zhefeng Wang, and Baoxing Huai, “Copyne: Better contextual asr by copying named entities,” arXiv preprint arXiv: 2305.12839, 2023.
[25] Anmol Gulati et al., “Conformer: Convolution-augmented transformer for speech recognition,” in Proc. Interspeech, 2020, pp. 5036-5040.
[26] Daniel S Park, William Chan, Yu Zhang, Chung-Cheng Chiu, Barret Zoph, Ekin D Cubuk, and Quoc V Le, “SpecAugment: A simple data augmentation method for automatic speech recognition,” in Proc. Interspeech, 2019, pp. 2613-2617.
[27] Vassil Panayotov, Guoguo Chen, Daniel Povey, and Sanjeev Khudanpur, “Librispeech: an asr corpus based on public domain audio books,” in Proc. ICASSP, 2015, pp. 5206-5210.
[28] ShinjiWatanabe et al., “ESPnet: End-to-end speech processing toolkit,” in Proc. Interspeech, 2018, pp. 2207-2211.
[29] Duc Le, Jain, et al., “Contextualized streaming end-to-end speech recognition with trie-based deep biasing and shallow fusion,” in Proc. Interspeech, 2021, pp. 1772-1776.
[30] Kikuo Maekawa, “Corpus of spontaneous Japanese: Its design and evaluation,” in ISCA & IEEE Workshop on Spontaneous Speech Processing and Recognition, 2003.
[31] Akira Kurematsu et al., “Atr japanese speech database as a tool of speech recognition and synthesis,” Speech Communication, vol. 9, no. 4, pp. 357-363, 1990.

What is claimed is:

1. A speech recognition method that generates text from speech data, the speech recognition method comprising:
transforming, by an audio encoder, an audio feature sequence of the speech data to hidden state vectors;
transforming, by a bias encoder, registered bias phrases to a phrase-level feature sequence;
recursively estimating, by a bias decoder, from a previous token estimated as the text, a next token based on the hidden state vectors and the phrase-level feature sequence and estimating bias phrase index probabilities for the next token; and
estimating a bias phrase index for the next token based on the bias phrase index probabilities, increasing a token probability for the bias phrase corresponding to the bias phrase index, and performing a beam search for the estimated next token.

2. The speech recognition method according to claim 1, wherein
the bias phrase index probabilities for the next token are estimated for each bias phrases by the bias decoder, and
the bias phrase index for the next token is estimated based on a maximum value of the bias phrase index probabilities.

3. The speech recognition method according to claim 1, wherein
the token probability for the bias phrase corresponding to the bias phrase index is increased by weighting the token probability.

4. The speech recognition method according to claim 1, wherein
the bias encoder comprises a bias attention layer that estimates the bias phrase index probabilities.

5. A speech recognition device that generates text from speech data using a model of an automatic speech recognition, the model comprising:
an audio encoder configured to transform an audio feature sequence of the speech data to hidden state vectors;
a bias encoder configured to transform registered bias phrases to a phrase-level feature sequence; and
a bias decoder configured to recursively estimate, from a previous token estimated as the text, a next token based on the hidden state vectors and the phrase-level feature sequence and to estimate bias phrase index probabilities for the next token;
wherein the speech recognition device is configured to estimate a bias phrase index for the next token based on the bias phrase index probabilities, to increase a token probability for the bias phrase corresponding to the bias phrase index, and to perform a beam search for the estimated next token.
